(19) United States
(12) Patent Application Publication
(10) Pub. No.: US 2010/0090158 A1
(43) Pub. Date: Apr. 15, 2010

(54) ALKALINE AQUEOUS SOLUTION COMPOSITION FOR TREATING A SUBSTRATE

(75) Inventors: Norio Ishikawa, Saitama (JP); Kikue Morita, Tokyo (JP)

Correspondence Address: WOLF GREENFIELD & SACKS, P.C., 600 ATLANTIC AVENUE, BOSTON, MA, 02210-2206, US

(73) Assignee: Kanto Kagaku Kabushiki Kaisha, Tokyo (JP)

(21) Appl. No.: 12/576,519

(22) Filed: Oct. 9, 2009

(30) Foreign Application Priority Data
Oct. 9, 2008 (JP) 2008-262982

(51) Int. Cl. C09K 13/02; C09K 13/00

(52) U.S. Cl. 252/79.5; 252/79.1

(57) ABSTRACT

An aqueous solution of ammonia, tetramethylammonium hydroxide and sodium hydroxide, etc. has been used as a cleaning liquid and an etching liquid of a semiconductor substrate and a glass substrate. However, the metal impurities in the alkali components are adsorbed onto the substrate surface during treatment, so that a process for removing the adsorbed metal impurities is necessary as the next process. In addition, in the case of the cleaning liquid, though it is effective in the removal of fine particles, the metal impurities cannot be cleaned, so that it is necessary to carry out acid cleaning, which makes the process complicated. According to the present invention, the alkaline aqueous solution for treating a substrate wherein an alkali component and a specific chelating agent are combined prevents adsorption of metal impurities onto the substrate, and further cleans and removes the metals adhered to the substrate. If necessary, it is also possible to add a metal anticorrosive and a surfactant to suppress corrosion of the metal materials, or enhance affinity to the substrate and ability for removing fine particles.

### FIELD OF THE INVENTION

The present invention relates to an alkaline aqueous solution composition for treating a substrate used for etching or cleaning of a substrate. More particularly, the present invention relates to an alkaline aqueous solution composition for treating a substrate for preventing metal impurities in the alkaline aqueous solution from adhering to the substrate surface, and further for cleaning and removing them in an etching process and a cleaning process using an alkaline aqueous solution carried out in the production process of a silicon wafer for semiconductor fabrication, the fabrication process of a semiconductor device, and the fabrication process of other electronic devices.

### BACKGROUND OF THE INVENTION

In the production process of a silicon wafer for semiconductor fabrication, when a wafer is cut out from a single-crystal ingot of silicon and processed in predetermined thickness, etching is carried out with an alkali such as sodium hydroxide and potassium hydroxide for the purpose of uniform etching. In this case, a large amount of metal impurities in sodium hydroxide and potassium hydroxides adheres to the wafer surface. Usually, it is then removed by cleaning with an acid such as dilute hydrofluoric acid, but, in particular, in a low resistance substrate in which boron etc. are diffused in high concentration, Cu and Ni are prone to diffuse internally, and, among these, as to Ni, diffusion occurs at around 80° C. that is the temperature in which sodium hydroxide and potassium hydroxide are used, so that in surface cleaning by an acid, it has been impossible to remove the metal impurities having diffused internally, which has been a problem.

In addition, actually, a large amount of transition metals such as Fe are adsorbed onto the silicon wafer surface besides Cu and Ni, which needs to be cleaned and removed by acidic cleaning liquid, etc., so that the process of production of a semiconductor is made long and complicated, which has led to the problems such as increase of cost and decrease of throughput.

In addition, in the final process of production of a silicon wafer and the fabrication process of a semiconductor device, in particular, alkaline cleaning liquid is used for the purpose of removing particles. For example, in the process for elaborating a transistor (Front End of Line), SC-1 cleaning liquid that is the mixture liquid of ammonia and hydrogen peroxide is used frequently, and in the cleaning process after CMP (chemical mechanical polish) that is a wiring process, an organic alkali such as tetramethylammonium hydroxide is used. Though these cleaning liquids do not contain a metal as a constituent, in this case also, metal impurities included as impurities in a cleaning liquid or a slight amount of metal impurities brought in from the previous process are adsorbed onto the wafer surface, so that there has been a fear that an electric characteristic is influenced.

As described above, the alkaline cleaning liquid does not have cleaning ability for metal impurities or conversely tends to adsorb them onto the substrate surface, so that it is a general cleaning process to combine it with an acidic cleaning liquid that can clean metal impurities, and the above-mentioned SC-1 cleaning liquid is used together with SC-2 cleaning liquid that is the aqueous solution of hydrochloric acid and hydrogen peroxide, or dilute hydrofluoric acid. This cleaning process holds about a third of the semiconductor fabrication process, and all of it is carried out with two kinds of liquids which are an alkaline cleaning liquid and an acid cleaning liquid, so that the process of semiconductor fabrication is long and complicated, which causes the problems such as increase of cost and decrease of throughput.

Furthermore, in the fabrication of a hard disc that is a large-capacity memory device, contamination with fine particles has been regarded as a problem conventionally, but the metal pollution has not heretofore, and cleaning with an alkali and an acid has been carried out. However, it has been proved that glass substrate is contaminated by the metal impurities in the alkaline cleaning liquids, and as a result, contamination with particles is caused, which causes the problem that is similar to a silicon substrate.

As countermeasures against these problems, use of various kinds of complexing agents (chelating agents) has been suggested in order to prevent metal adsorption in the alkaline aqueous solution. Aminocarboxylic acids such as ethylenediaminetetraacetic acid (EDTA) and diethylenetriaminepentaacetic acid (DTPA) has been known as a chelating agent for a long time, which has been suggested to the field of semiconductor production as well (JP, A, 2005-310845 and JP, A, 2006-165408), but the chelate compound is unstable, and the effect is not sufficient, which does not exert an effect in a wide range of concentration.

In addition, the use of various kinds of chelating agents and complexing agents are suggested, such as aminophosphonic acids (JP, A, 6-41773 and JP, B, 3503326), condensed phosphoric acids (JP, B, 3274834), the combination of phenols, etc. and amines, etc. (JP, A, 9-111224), thiocyanate (JP, A, 2005-038969), nitrite ion and nitrate ion (JP, A, 2005-210085). However, all of these chelating agents and complexing agents are intended for use in the SC-1 cleaning liquid that is the mixed liquid of ammonia and hydrogen peroxide, which is a representative cleaning liquid of the semiconductor process. Although they have an effect in a relatively weak alkaline solution such as ammonia, it is difficult to form a stable complex in a strong alkaline aqueous solutions such as sodium hydroxide and tetramethylammonium hydroxide, and sufficient effects are not recognized.

Therefore, it is the actual state that there is still no etching liquid and cleaning liquid for treating a substrate comprising strong alkaline components such as sodium hydroxide and tetramethylammonium hydroxide, that can effectively prevent adsorption of metal impurities in the alkaline component onto the substrate, and further effectively clean and remove the metals adsorbed onto the substrate.

### DISCLOSURE OF INVENTION

### Problems to be Solved by the Invention

The object of the present invention is to provide an alkaline aqueous solution composition for treating a substrate that can prevent metal adsorption onto the substrate surface and improve the electric characteristic of a semiconductor device and other electronic devices, and further contributes to improvement of the throughput in the etching process and the cleaning process of a substrate using a strong alkaline aqueous solution.

### Means for Solving the Problems

The present inventors have studied intensively in order to find an alkaline aqueous solution composition for treating a substrate that can solve the above-described problems, and as a result of it, it was found that a certain structure, i.e., an amino acid compound having an alcoholic hydroxyl group, forms a stable chelate with metals, such as Ni, Fe and Cu, and effectively prevents metal adsorption onto the substrate surface, even in a strong alkaline aqueous solution such as sodium hydroxide and tetramethylammonium hydroxide, and as a result of a further research, the present invention has completed.

That is, the present invention relates to an alkaline aqueous solution composition for treating a substrate, comprising an alkaline component, and one or more chelating agents selected from the group consisting of dihydroxyethyl glycine, 3-hydroxy-2,2′-iminodisuccinic acid, serine and salts thereof.

Moreover, the present invention relates to the above-described alkaline aqueous solution composition for treating a substrate, wherein the alkaline component is sodium hydroxide or potassium hydroxide, which is used for etching or cleaning of a silicon wafer.

Further, the present invention relates to the above-described alkaline aqueous solution composition for treating a substrate, wherein the concentration of sodium hydroxide or potassium hydroxide is 10-50% by weight, and the concentration of the chelating agent is 0.001-1.0% by weight, which is used for etching of a silicon wafer.

Moreover the present invention relates to the above-described alkaline aqueous solution composition for treating a substrate, wherein the concentration of sodium hydroxide or potassium hydroxide is 0.05-10.0% by weight, and the concentration of the chelating agent is 0.001-1.0% by weight, which is used for cleaning of a silicon wafer.

Further, the present invention relates to the above-described alkaline aqueous solution composition for treating a substrate, wherein the alkaline component is tetramethylammonium hydroxide, which is used for cleaning of a substrate.

Moreover, the present invention relates to the above-described alkaline aqueous solution composition for treating a substrate, wherein the concentration of tetramethylammonium hydroxide is 0.01-1.0% by weight, and the concentration of the chelating agent is 0.001-1.0% by weight.

Further, the present invention relates to the above-described alkaline aqueous solution composition for treating a substrate, further comprising an anticorrosive.

Moreover, the present invention relates to the above-described alkaline aqueous solution composition for treating a substrate, further comprising a surfactant.

Further, the present invention relates to the above-described alkaline aqueous solution composition for treating a substrate, further comprising another chelating agent.

Moreover, the present invention relates to an etching or cleaning method of a substrate, using the above-described alkaline aqueous solution composition for treating a substrate.

The mechanism that the alkaline aqueous solution composition for treating a substrate of the present invention prevents adsorption of the metal such as Ni onto the substrate surface quite effectively while it is a strongly alkaline aqueous solution, is not always clear.

In general, the chelating agent having an alcoholic hydroxyl group, such as gluconic acid is known as an effective chelating agent in the alkaline aqueous solutions, but an effect is not recognized in the strongly alkaline aqueous solutions comprising sodium hydroxide or potassium hydroxide of high concentration of 10% by weight or more. According to the present invention, it is considered that an O atom and an N atom being coordinating atoms within the same molecule form a coordination bond with a metal such as Ni more strongly in the optimal positional relationships to form a stable chelate, even in a strong alkaline aqueous solution comprising sodium hydroxide, potassium hydroxide and tetramethylammonium hydroxide, etc. by using an amino acid compound having a certain structure comprising both alcoholic hydroxyl group and a nitrogen atom within the same molecule as a chelating agent.

### EFFECTS OF THE INVENTION

In the etching process and the cleaning process of the semiconductor fabrication process, etc. using an alkaline solution, the present alkaline aqueous solution composition for treating a substrate enables to effectively prevent adsorption of metal impurities in the alkaline component onto the substrate and further to effectively clean and remove the metals adsorbed onto the substrate, so that it is possible to omit the subsequent acidic cleaning, etc., which leads to large shortening of the cleaning process, and decrease of the cost and increase of the throughput can be accomplished.

### BEST MODE FOR CARRYING OUT THE INVENTION

The present invention will be explained in detail below. The substrates to be treated according to the present invention, include a silicon wafer, a silicon substrate and other semiconductor substrates used in the fabrication of a semiconductor and a glass substrates for a flat-panel display and a hard disc, etc.

Moreover, the substrate treatments according to the present invention include etching of a silicon wafer, cleaning after etching of a silicon wafer, cleaning after CMP of a semiconductor substrate, receiving cleaning of a semiconductor substrate, and cleaning of a glass substrate for a flat-panel display and a hard disc, etc.

The chelating agent for prevention of metal adsorption used in the present invention is an amino acid compound having a hydroxyl group. From the viewpoint of being capable of forming a stable chelate in accordance with a wide range of alkali concentration and forming a stable chelate for metals such as Ni, Cu and Fe, etc., suitable amino acid compound having a hydroxyl group for the purpose of the present invention includes hydroxyethylimino diacetic acid, dihydroxyethyl glycine, 3-hydroxy-2,2′-iminodisuccinic acid, tyrosine, serine, threonine and salts thereof, etc., and preferably dihydroxyethyl glycine, 3-hydroxy-2,2′-iminodisuccinic acid, serine and salts thereof, etc. Furthermore, one or more of these chelating agents may be used in accordance with the application.

The concentration of these chelating agents is determined appropriately taking into consideration an effect in accordance with the purpose of use and the concentration of alkaline components, etc.

The concentration of the chelating agents when used as an etching liquid is preferably 0.001-1.0% by weight, and more preferably 0.01-0.5% by weight, and even more preferably 0.05-0.3% by weight.

Furthermore, the concentration of the chelating agents when used as a cleaning agent is also preferably 0.001-1.0% by weight, and more preferably 0.01-0.5% by weight, and even more preferably 0.05-0.3% by weight.

If the concentration of the chelating agent is excessively low, a sufficient effect in accordance with the purpose of use is not exerted, and if the concentration is excessively high, an economic effect in proportion to the concentration cannot be obtained, which further becomes the cause of separating out, etc. during storing. On the other hand, if the concentration of the chelating agent is within the above-described range, sufficient effects in accordance with the purpose of use and stability during storing can be obtained, which is therefore preferable.

The alkaline component used in the present invention is an alkaline component used for the purpose of etching or cleaning in fabrication of a semiconductor and other electronic devices, and preferably includes inorganic alkalis such as sodium hydroxide, potassium hydroxide, organic alkalis such as tetramethylammonium hydroxide, trimethyl(hydroxyethyl)ammonium hydroxide, ammonia used for SC-1 cleaning liquid, etc.

In case of being used for etching or cleaning of the silicon wafer, more preferably sodium hydroxide, potassium hydroxide, etc. are mentioned, and in case of being used for the substrate cleaning of a semiconductor and other electronic devices, more preferably tetramethylammonium hydroxide, etc. are mentioned.

The concentration of these alkaline components is determined appropriately taking into consideration an effect in accordance with the purpose of use, etc.

In the case of etching liquid, it is used in a wide range of concentration of up to 10-50% by weight in accordance with the purpose. In case that an alkaline component is sodium hydroxide or potassium hydroxide, it is used in the concentration of preferably 10-50% by weight, more preferably 20-50% by weight, further preferably 30-50% by weight, taking etching speed into consideration.

In the case of cleaning liquid, it is used in a wide range of concentration of up to 0.01-10% by weight in accordance with the purpose. In case that an alkaline component is sodium hydroxide or potassium hydroxide, it is used in the concentration of preferably 0.05-10% by weight, more preferably 0.05-5% by weight, further preferably 0.2-1.0% by weight, taking into consideration ability for cleaning and a cost. In case that an alkaline component is tetramethylammonium hydroxide, it is used in the concentration of preferably 0.01-1.0% by weight, more preferably 0.05-0.8% by weight, further preferably 0.1-0.5% by weight, taking into consideration sufficient cleaning effects and prevention of damage against the substrate.

In addition, when the aqueous solution composition of the present invention comprising tetramethylammonium hydroxide or trimethyl(hydroxyethyl)ammonium hydroxide is used as a cleaning liquid of a semiconductor substrate, because in the cleaning process after CMP (chemical mechanical polish) that is a wiring process, cleaning liquid contacts with wiring materials such as aluminum and copper, it may further comprise an anticorrosive in order to prevent corrosion of wiring materials.

As to an anticorrosive used for the present invention, general corrosion inhibitor of aluminum and copper used for substrate treatment in production of semiconductor and other electronic devices may be used. The corrosion inhibitor of aluminum preferably includes sugars such as sorbitol, compounds having a phenolic hydroxyl group such as catechol and gallic acid, polymeric compounds having a carboxyl group such as polyacrylic acid, etc., and the corrosion inhibitor of copper, preferably includes a heterocyclic compound such as benzotriazole and thiourea, etc. Benzotriazole is particularly preferable.

The concentration used is preferably 0.01-5% by weight, more preferably 0.05-2% by weight, taking into consideration sufficient effects in accordance with a purpose of use and stability during storage, etc.

Furthermore, when the aqueous solution composition of the present invention comprising tetramethylammonium hydroxide or trimethyl(hydroxyethyl)ammonium hydroxide is used as a cleaning liquid of a semiconductor substrate, it may further comprise a surfactant in order to increase the ability for removing fine particles or to improve the wettability between the cleaning liquid and the insulation film in the cleaning process after CMP (chemical mechanical polish) that is a wiring process.

As to a surfactant used for the present invention, a general surfactant used for substrate treatment in fabrication of a semiconductor and other electronic devices may be used, and preferably non-ionic surfactants, etc. are included, and in particular the ones with the structure of polyoxyalkylene alkyl ether and polyoxyalkylene alkyl phenyl ether are preferable.

The concentration of the surfactant is preferably 0.01-5% by weight, more preferably 0.05-2% by weight, taking into consideration sufficient effects in accordance with a purpose of use and stability during storage, etc.

The present invention can further be used together with other chelating agents such as polyaminocarboxylic acids. Many of chelating agents have specificity for an effect for metals, and using of plural chelating agents in combination is effective for preventing adsorption of a wide variety of metals and cleaning. For the other metal impurities other than Fe, Ni and Cu, it is preferable to use other chelating agents in combination because the effect of preventing metal adsorption is more improved.

Other chelating agents used for the present invention are chelating agents used for etching or cleaning in fabrication of a semiconductor and other electronic devices, which include preferably, aminocarboxylic acids such as ethylenediaminetetraacetic acid and nitrilotriacetic acid, organic acids such as citric acid and tartaric acid, nitrogen containing heterocyclic compounds such as phenanthroline, etc. In particular, ethylenediaminetetraacetic acid is preferable because it forms complexes with a wide variety of metals.

The concentration of chelating agent is preferably 0.001-1% by weight, more preferably 0.01-0.5% by weight, taking into consideration sufficient effects in accordance with a purpose of use and stability during storage, etc.

The etching method of a substrate according to the present invention typically includes a spray treatment in which an etching liquid is supplied from a spray nozzle onto a substrate and a dip treatment in which a substrate is dipped directly in etching liquid and the substrate itself is fluctuated or etching liquid is stirred, etc.

Moreover, the cleaning method of the substrate according to the present invention, typically includes batch type cleaning in which a substrate is dipped directly in the cleaning liquid and sheet type cleaning in which cleaning liquid is supplied from a nozzle onto the substrate surface while spin rotating the substrate, etc. Further, methods in which physical cleaning such as brush scrub cleaning by means of a sponge brush made of polyvinyl alcohol, etc. and megasonic cleaning using a high frequency used together with the above-described cleaning method, etc. are included.

### EXAMPLES

In the following, the present invention will be explained in more detail by way of Examples and Comparative examples, but the present invention is not limited to these Examples, and various changes are possible without deviating from the technical idea of the present invention.

### Example 1

### The Etching Liquid Comprising 48% by Weight of Sodium Hydroxide

A clean silicon wafer (n type, plain direction: 100) was dipped in dilute hydrofluoric acid with the concentration of 0.5% by weight at 25° C. for one minute, and then rinsed with water for 1 minute, so as to remove a native oxide layer. This silicon wafer was etched by dipping in the etching liquid with the composition shown in Table 1 in which solvent was water at 80° C. for 10 minutes, and then rinsed with water for 5 minutes and dried. The concentration of Ni, Fe and Cu on this silicon wafer surface was measured using a total reflection X-ray fluorescence device. The measurement results are given in Table 1.

TABLE 1

| | Composition *1 | | | | | |
|---|---|---|---|---|---|---|
| | NaOH | | | Surface | | |
| | (% by | Chelating agent | | concentration *2 | | |
| Example No | weight) | (ppm) | | Ni | Fe | Cu |
| Example 1 | 48.0 | DHEG | 1000 | 390 | 450 | <1 |
| Comparative | 48.0 | None | | 91000 | 78000 | 370 |
| example 1 | | | | | | |
| Comparative | 48.0 | DTPA | 1000 | 74000 | 67000 | 290 |
| example 2 | | | | | | |
| Comparative | 48.0 | EDTA | 1000 | 83000 | 59500 | 350 |
| example 3 | | | | | | |
| Comparative | 48.0 | AcAc | 1000 | 65200 | 56900 | 355 |
| example 4 | | | | | | |
| Comparative | 48.0 | Gluconic acid | 1000 | 81000 | 67000 | 364 |
| example 5 | | | | | | |

*1: The rest is water.
*2: Unit: ×10¹⁰ atoms/cm²
DHEG: Dihydroxyethyl glycine
DTPA: Diethylenetriaminepentaacetic acid
EDTA: Ethylenediaminetetraacetic acid
AcAc: Acetylacetone

From the results of Table 1, in the strong alkaline etching liquid with the concentration of sodium hydroxide of 48% by weight, the adsorption quantity of metal impurities included in sodium hydroxide, such as Ni, Fe and Cu onto the substrate treated with the etching liquids of Comparative examples 2-5 to which a conventional chelating agent was added, shows the concentration comparable to Comparative example 1 to which chelating agent was not added, so that it indicates that adsorption of metal impurities onto the substrate can not be prevented. In contrast, the etching liquid of Example 1 to which dihydroxyethyl glycine was added as a chelating agent can prevent the adsorption of metal impurities onto the substrate quite effectively.

### Example 2

### The Etching Liquid Comprising 40% by Weight of Sodium Hydroxide

A clean silicon wafer (n type, plain direction: 100) was dipped in dilute hydrofluoric acid with the concentration of 0.5% by weight at 25° C. for 1 minute and then rinsed with water for 1 minute, so as to remove a native oxide layer. This silicon wafer was etched by dipping in the etching liquid with the composition shown in Table 2 in which solvent was water at 80° C. for 10 minutes, and then rinsed with water for 5 minutes and dried. The concentration of Ni, Fe and Cu on this silicon wafer surface was measured using a total reflection X-ray fluorescence device. The measurement results are given in Table 2.

TABLE 2

| | Composition *1 | | | | | |
|---|---|---|---|---|---|---|
| | NaOH | | | Surface | | |
| | (% by | Chelating agent | | concentration *2 | | |
| Example No | weight) | (ppm) | | Ni | Fe | Cu |
| Example 2 | 40.0 | DHEG | 1000 | 210 | 1330 | <1.0 |
| Example 3 | 40.0 | DHEG | 2000 | 28 | 130 | <1.0 |
| Comparative | 40.0 | None | | 76000 | 153000 | 580 |
| example 6 | | | | | | |
| Comparative | 40.0 | EDTA | 1000 | 9800 | 11500 | 380 |
| example 7 | | | | | | |
| Comparative | 40.0 | CyDTA | 1000 | 11000 | 7500 | 110 |
| example 8 | | | | | | |
| Comparative | 40.0 | Gluconic acid | 1000 | 7560 | 8960 | 425 |
| example 9 | | | | | | |

*1: The rest is water.
*2: Unit: ×10¹⁰ atoms/cm²
CyDTA: Trans-1,2-cyclohexanediaminetetraacetic acid

From the results of Table 2, in the strong alkaline etching liquid with the concentration of sodium hydroxide of 40% by weight, the adsorption of metal impurities onto the substrate treated with the etching liquids of Comparative examples 7-9 to which a conventional chelating agent was added was less than Comparative example 6 to which chelating agent was not added, but it indicates that adsorption can not be sufficiently prevented. In contrast, it indicates that, the adsorption of metal impurities onto the substrate treated with the etching liquid of Examples 2 and 3 to which dihydroxyethyl glycine was added as a chelating agent, can be prevented quite effectively.

### Example 3

### The Etching Liquid Comprising 10% by Weight of Sodium Hydroxide

A clean silicon wafer (n type, plain direction: 100) was dipped in dilute hydrofluoric acid with the concentration of 0.5% by weight at 25° C. for 1 minute and then rinsed with water for 1 minute, so as to remove a native oxide layer. This silicon wafer was etched by dipping in the etching liquid with the composition shown in Table 3 in which solvent was water at 80° C. for 10 minutes, and then rinsed with water for 5 minutes and dried. The concentration of Ni and Fe on this silicon wafer surface was measured using a total reflection X-ray fluorescence device. The measurement results are given in Table 3.

TABLE 3

| | Composition *1 | | | | |
|---|---|---|---|---|---|
| | NaOH | | | Surface | |
| | (% by | Chelating agent | | concentration *2 | |
| Example No | weight) | (ppm) | | Ni | Fe |
| Example 4 | 10.0 | DHEG | 1000 | 7 | 2 |
| Example 5 | 10.0 | DHEG | 2000 | 1 | 1 |
| Example 6 | 10.0 | Serine | 1000 | 10 | 4 |
| Comparative | 10.0 | None | | 675 | 12 |
| example 10 | | | | | |
| Comparative | 10.0 | EDTA | 2000 | 40 | 9 |
| example 11 | | | | | |
| Comparative | 10.0 | DTPA | 2000 | 48 | 11 |
| example 12 | | | | | |

*1: The rest is water.
*2: Unit: ×10¹⁰ atoms/cm²

From the results of Table 3, it indicates that, in the strong alkaline etching liquid with the concentration of sodium hydroxide of 10% by weight, the adsorption of metal impurities to the substrate treated with the etching liquids of Comparative examples 11 and 12 to which a conventional chelating agent was added is less compared to Comparative example 10 to which chelating agent was not added, but adsorption can not be sufficiently prevented. In contrast, it indicates that, with the etching liquid of Examples 4-6 to which dihydroxyethyl glycine and serine were added as chelating agents, adsorption of metal impurities onto the substrate can be prevented quite effectively.

### Example 4

### The Etching Liquid Comprising 48% by Weight of Potassium Hydroxide

A clean silicon wafer (n type, plain direction: 100) was dipped in dilute hydrofluoric acid with the concentration of 0.5% by weight at 25° C. for 1 minute, then rinsed with water for 1 minute, so as to remove a native oxidized layer. This silicon wafer was etched by dipping in the etching liquid with the composition shown in Table 4 in which solvent was water at 80° C. for 10 minutes, and then rinsed with water for 5 minutes and dried. The concentration of Ni, Fe and Cu on this silicon wafer surface was measured using a total reflection X-ray fluorescence device. The measurement results are given Table 4.

TABLE 4

| | Composition *1 | | | | | | | |
|---|---|---|---|---|---|---|---|---|
| | KOH | Chelating | | Chelating | | Surface | | |
| | (% by | agent 1 | | agent 2 | | concentration *2 | | |
| Example No | weight) | (ppm) | | (ppm) | | Ni | Fe | Cu |
| Example 7 | 48.0 | DHEG | 1000 | — | | 47 | 86.0 | 9.5 |
| Example 8 | 48.0 | DHEG | 2000 | — | | 20 | 7.0 | <1.0 |
| Example 9 | 48.0 | HIDS | 1000 | — | | 41 | 110 | <1.0 |
| Example 10 | 48.0 | DHEG | 2000 | HIDS | 1000 | 13 | 5.6 | <1.0 |

| Comparative | 48.0 | None | | — | 3000 | 4100 | 950 |
|---|---|---|---|---|---|---|---|
| example 13 | | | | | | | |
| Comparative | 48.0 | EDTA | 1000 | — | 2200 | 3500 | 720 |
| example 14 | | | | | | | |

*1: The rest is water.
*2: Unit: ×10¹⁰ atoms/cm²
HIDS: 3-Hydroxy-2,2′-iminodisuccinic acid

From the results of Table 4, in the strong alkaline etching liquid with the concentration of potassium hydroxide of 48% by weight, the adsorption quantity of metal impurities comprised in potassium hydroxide, such as Ni, Fe and Cu, onto the substrate treated with the etching liquids of Comparative example 14 to which a conventional chelating agent was added was comparable to those of Comparative example 13 to which chelating agent was not added, so that it indicates that adsorption of metal impurities onto the substrate can not be prevented. In contrast, it indicates that the etching liquids of Examples 7-10 to which dihydroxyethyl glycine and 3-hydroxy-2,2′-iminodisuccinic acid were added as chelating agents can prevent adsorption of metal impurities onto the substrate quite effectively.

Furthermore, it indicates that the etching liquid of Example 10 to which above-described two kinds of chelating agents were added in combination can prevent the adsorption of metal impurities onto the substrate more effectively, comparing to the etching liquids of Examples 7-9 to which only one kind of chelating agent was added.

### Example 5

### The Cleaning Liquid Comprising 0.2% by Weight of Tetramethylammonium Hydroxide

A clean silicon wafer (n type, plain direction: 100) was dipped in dilute hydrofluoric acid with the concentration of 0.5% by weight at 25° C. for 1 minute, then rinsed with water for 1 minute and the wafer was further dipped in the mixed solution of ammonia (29%), hydrogen peroxide (28%) and water (volume ratio 1:1:6) to form a native oxidized layer on the surface. This wafer with native oxidized layer was polluted by compulsion using Fe and Ni standard solution for atomic absorption so that the surface concentration was 2×10¹² atms/cm².

Then, this silicon wafer polluted by compulsion was dipped in the cleaning liquid with the composition shown in Table 5 in which solvent was water at 25° C. for 3 minutes to clean, and then rinsed for 5 minutes and dried. The concentration of Fe and Ni on this silicon wafer surface was measured using a total reflection X-ray fluorescence device. The measurement results are shown in Table 5.

TABLE 5

| | Composition *1 | | | | | |
|---|---|---|---|---|---|---|
| | TMAH | Chelating | | | Surface | |
| | (% by | agent | | | concentration * | |
| Example No | weight) | (ppm) | | Others | Fe | Ni |
| Example 11 | 0.2 | DHEG | 1000 | — | 47 | 5.0 |
| Example 12 | 0.2 | DHEG | 1000 | Anticorrosive | 50 | 7.0 |
| | | | | BTA 1.0% | | |
| Example 13 | 0.2 | HIDS | 1000 | — | 3.6 | <1.0 |
| Example 14 | 0.2 | HIDS | 1000 | DKSdash408 | 4.0 | <1.0 |
| | | | | 100 ppm | | |

| | | | | | |
|---|---|---|---|---|---|
| Comparative | 0.2 | None | — | 50 | 170 |
| example 15 | | | | | |

*1: The rest is water.
*2: Unit: ×10¹⁰ atoms/cm²
BTA: Benzotriazole
DKSdash408: Polyoxyalkylene alkyl ether type surfactant manufactured by Dai-ichi Kogyo Seiyaku Co., Ltd.

From the results of Table 5, it indicates that, in the strong alkaline cleaning liquid with the concentration of tetramethylammonium hydroxide of 0.2% by weight, the cleaning liquids of Examples 11-14 to which dihydroxyethyl glycine and 3-hydroxy-2,2′-iminodisuccinic acid were added as chelating agents can clean metal impurities on the substrate surface quite effectively.

Furthermore, it indicates that addition of an anticorrosive and a surfactant does not affect cleaning ability of the cleaning liquid.

From the results of above Table 1-5, it indicates that the alkaline aqueous solution for treating a substrate of the present invention prevents adsorption of metal impurities such as Ni, Fe and Cu onto the substrate surface quite effectively and also can clean metal contamination of the substrate surface, even under the strong alkaline condition that comprises sodium hydroxide, potassium hydroxide or tetramethylammonium hydroxide, by adding an amino acid compound with the specified structure having both alcoholic hydroxyl group and nitrogen atom within a molecule as a chelating agent.

In addition, it can be assumed and recognized that the chelating agents having these specific structures can form stable chelates with metals such as Ni, Fe and Cu, even in a strong alkaline aqueous solution.

### INDUSTRIAL APPLICABILITY

It becomes possible to effectively prevent adsorption of metal impurities in the alkali component onto the substrate and further to effectively clean and remove the metal adsorbed onto the substrate by etching or cleaning a silicon wafer, a semiconductor substrate and a glass substrate, etc., using the alkaline aqueous solution composition for treating a substrate of the present invention, so that large shortening of the cleaning process is brought about, and decrease of the cost and increase of the throughput can be accomplished, and further the electric characteristics of semiconductor devices, etc. can be improved. Therefore, it is particularly useful in the technical field of fabrication of a semiconductor device and other electronic devices, flat-panel display and the hard disc, etc. in which an alkaline etching liquid and a cleaning liquid are used.

1. An alkaline aqueous solution composition for treating a substrate, comprising an alkaline component, and one or more chelating agents selected from the group consisting of dihydroxyethyl glycine, 3-hydroxy-2,2′-iminodisuccinic acid, serine and salts thereof.

2. The alkaline aqueous solution composition for treating a substrate according to claim 1, wherein the alkaline component is sodium hydroxide or potassium hydroxide, which is used for etching or cleaning of a silicon wafer.

3. The alkaline aqueous solution composition for treating a substrate according to claim 2, wherein the concentration of sodium hydroxide or potassium hydroxide is 10-50% by weight, and the concentration of the chelating agent is 0.001-1.0% by weight, which is used for etching of a silicon wafer.

4. The alkaline aqueous solution composition for treating a substrate according to claim 2, wherein the concentration of sodium hydroxide or potassium hydroxide is 0.05-10.0% by weight, and the concentration of the chelating agent is 0.001-1.0% by weight, which is used for cleaning of a silicon wafer.

5. The alkaline aqueous solution composition for treating a substrate according to claim 1, wherein the alkaline component is tetramethylammonium hydroxide, which is used for cleaning of a substrate.

6. The alkaline aqueous solution composition for treating a substrate according to claim 5, wherein the concentration of tetramethylammonium hydroxide is 0.01-1.0% by weight, and the concentration of the chelating agent is 0.001-1.0% by weight.

7. The alkaline aqueous solution composition for treating a substrate according to claim 5, further comprising an anticorrosive.

8. The alkaline aqueous solution composition for treating a substrate according to claim 5, further comprising a surfactant.

9. The alkaline aqueous solution composition for treating a substrate according to claim 1, further comprising another chelating agent.

10. A method comprising treating a substrate with the alkaline aqueous solution composition according to claim 1.
